(19) United States
(12) Patent Application Publication
(10) Pub. No.: US 2026/0154072 A1
(43) Pub. Date: Jun. 4, 2026

(54) DYNAMICALLY PERSONALIZED SOFTWARE FEATURE TOURS

(71) Applicant: T-Mobile USA, Inc., Bellevue, WA (US)

(72) Inventors: Arvind Krishnamoorthy, Issaquah, WA (US); James Byung Ha No, Covington, WA (US); Scott T. Quach, Kirkland, WA (US); Jeny Bhimani, Bothell, WA (US)

(21) Appl. No.: 18/969,026

(22) Filed: Dec. 4, 2024

(51) Int. Cl. G06F 8/73

(52) U.S. Cl. CPC G06F 8/73

(57) ABSTRACT

Feature discovery in computer applications is a significant challenge. Existing approaches often lack personalization and are of limited utility. Described herein are approaches for providing personalized feature tours to users of computer applications. In some implementations, tours are recommended based at least in part on prioritizations defined by application developers. In some implementations, tours are recommended based at least in part on past user behavior, the behavior of other users, or both. In some implementations, a personalized feature tour system tailors tours, for example by omitting steps, based on a user's past usage of an application. In some implementations, a personalized feature tour system is configured for particular frameworks or is framework-agnostic. The personalized feature tour system can be used for web applications, mobile applications, and/or desktop applications.

### BACKGROUND

Software applications often add new features, modify existing features, or contain features that users are otherwise unaware of or don't understand the full capabilities of. Feature discovery in software applications has proven challenging. Accordingly, there is a need for improved approaches to feature discovery.

### BRIEF DESCRIPTION OF THE DRAWINGS

Detailed descriptions of implementations of the present invention will be described and explained through the use of the accompanying drawings.

FIG. 1 is a block diagram that illustrates an example personalized feature tour platform according to some implementations.

FIG. 2 shows an example feature discovery definitions table according to some implementations.

FIG. 3 shows an example of a user recommendation table according to some implementations.

FIG. 4 is a block diagram that illustrates certain features of a personalized tour recommendation system and an application that interacts with the personal tour recommendation system according to some implementations.

FIG. 5 illustrates an example entry in a tour table according to some implementations.

FIG. 6 is a diagram that shows an example of linkage between a tour table 110 can an application information table.

FIG. 7 is a drawing that illustrates an example API request according to some implementations.

FIG. 8 is a flowchart that illustrates an example process for creating and managing feature tours according to some implementations.

FIG. 9 is a flowchart that illustrates an example tour deployment process according to some implementations.

FIG. 10 is a flowchart that illustrates an example process for creating and modifying a feature tour according to some implementations.

FIG. 11A is a drawing that illustrates an example user interface according to some implementations.

FIG. 11B is a drawing that illustrates a user interface for a tour step according to some implementations.

FIG. 12 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

Applications can offer various features and functionality. In some cases, users may not be aware of all the features of an application. Some features may not be relevant to the user, while other undiscovered features may be of interest to the user. Lack of knowledge about which features are present in an application or how to use them effectively can lead to wasted time, inability to complete certain tasks, and so forth. As an example, a user of a word processor application may have little use for reference management features, but their work could be made easier if they understood how to properly utilize styles. In some cases, users may have a basic understanding of certain functionality, but may not be aware of or understand how to use more advanced functionality. As an example, a user may take advantage of styles in a word processing application to maintain consistent formatting, but the user may be unaware of how to use styles to determine what appears in an automatically generated table of contents.

Feature discovery can be difficult for a variety of reasons. For example, an application may have many features, which can make it difficult for a user to find features that are relevant to their use cases. This can be particularly true for complex applications such as spreadsheets, word processors, computer aided drafting (CAD) tools, design tools, data analysis tools, and so forth. In some cases, features can be difficult to locate because they rely on interactions that may not be immediately obvious, such as long-pressing on a user interface element, right clicking, double clicking, etc. Without guidance, users may take a long time to discover certain features or may never discover certain features.

In some cases, users may explore an application to determine what features are present. However, once a user has learned to use an application to accomplish a particular task or tasks, they may stop exploring the application and thus can remain unaware of additional features that already exist in the application or that are later added to the application. For example, a user may know one way to conduct a certain analysis task. When a developer updates the application to introduce a new or improved feature that could make the analysis task easier or more efficient, the user may not know about the new or improved feature and may be unlikely to seek out the new or improved feature because they already know how to accomplish the task. Additionally, user exploration may be of limited utility for applications that include large numbers of features or which take advantage of user interactions that are not immediately apparent.

While users may eventually discover certain features, they may only do so through accident rather than active exploration of the application. Furthermore, even if a user does stumble across a feature, they may not understand how they accessed the feature and thus may struggle to use the feature again in the future. This can be especially likely in cases where complicated or atypical interactions are used to trigger certain features.

In some cases, users may discover a set of features that allows them to accomplish a particular task. Users may not explore further or may only occasionally explore the application. In some cases, this can result in users following inefficient processes to complete their tasks, for example, because they are unaware of other functionality that could speed up or simplify their tasks, or because they don't understand how to use such functionality. As an example, a user of a spreadsheet program may learn to use filters, conditional functions, and so forth to carry out certain data analysis tasks. While these can be effective, in many cases these tasks could be sped up significantly if the user understood how to utilize features such as pivot tables or other more advanced features. moreover, by using built-in advanced features instead of “reinventing the wheel,” users may obtain more reliable results as they avoid or at least lessen the need to create custom formulas, which may have errors or make assumptions that break over time, for carrying out their analyses.

In some cases, developers can create new features over time that improve upon or offer alternatives to existing features. However, users who are already comfortable with the existing features may be unaware of the new features, or may not understand how or why to use the new features. As an example, combining index( ) and match( ) functions in spreadsheet programs has long been used to look up data in a larger dataset. However, index( ) and match( ) can be complicated to use and can frequently result in errors, which can take significant time to fix or which may go unnoticed. Many users could benefit from using the newer xlookup( ) function, which has simpler syntax, more sensible default settings (e.g., matching on exact matches only by default), built-in error handling (thereby obviating the need to wrap lookups in error handling functions), improved performance, and so forth.

In some cases, users may be unaware that an application offers certain functionality at all. In such cases, users may rely on other applications to carry out certain tasks. For example, a user may be unaware that a data exploration application includes certain analysis functionality, and may export data and work with it in another application such as a spreadsheet program.

Software publishers and developers have tried many approaches for educating users about the features and functionality of their software. However, such approaches have left much to be desired, as users may find such approaches confusing, annoying, etc. In some cases, users may not even be aware of a publisher or developer's efforts to educate them.

For example, conventional discovery techniques such as providing release notes, documentation, web tutorials, etc., may be of limited utility because they require users to seek out information that the users may not even know is relevant, and much of which may be irrelevant. In some cases, users may not even realize such information exists. Even if such information is presented to a user, for example as a popup that appears when an application is updated, users often ignore this information, finding it irrelevant or overwhelming, assuming they engage with the information at all.

In some cases, developers may use tool tips or other in-application popups to provide information about features to users. However, these are often poorly targeted, can appear at inconvenient times, may not be specific to the user, etc. For example, immediately before a video conference meeting is likely a poor time to expose a new feature in a videoconferencing application to a user. If the user dismisses the indication of a new feature, the user may never come back and discover what the new feature actually is or does. Accordingly to some implementations described herein, features can be exposed to users at more opportune times and/or can be resurfaced to users at multiple times.

Moreover, merely pointing out that a specific feature exists may be of limited utility. While simply bringing a particular feature to a user's attention can be beneficial in some cases, in others, it can be important to walk the user through a scenario or use case that demonstrates when and how the feature can be used effectively.

Additionally, it can be important to tailor experiences for particular users. For example, presenting a new or updated feature that a user is unlikely to be interested in can be distracting or annoying to the user, and can dissuade the user from other discovery experiences directed to features the user may be interested in.

Accordingly, there is a need for approaches that can be used to help users discover functionality and understand how they can make use of features. As described herein, personalized functionality discovery approaches can provide tailored experiences to users to help them discover functionality that may be of interest to them. In some implementations, personalized tours are provided. Personalized tours can be repeated to help users cement knowledge of functionality. This can be especially important for more complex features or workflows, where repeated exposure can be important for users to truly understand and embrace certain functionality. In some implementations, a recommendation architecture for feature discovery can include a feature discovery definition table (also referred to herein as a feature discovery incubator), a recommendation engine, and a feature tour schema and associated application programming interface (API). Aspects of a feature discovery incubator are described in U.S. Pat. No. 12,061,713, the contents of which are incorporated by reference herein. In some implementations, feature tours utilize custom graphical implementations. In some implementations, feature tours utilize functionality built into another library, such as ngx-ui-tour for Angular-based applications. It will be appreciated, however, that the approaches described herein are not limited to any particular front-end library.

As described herein, applications can include many features, not all of which are relevant to a user. In some implementations, tour recommendations can be based on the users past interaction with an application. For example, tours can be offered for features that are similar or related to features the user has used in the past, or can be offered when there is a significant modification to a feature the user has used in the past. In some implementations, tours recommendations can be based on the behavior of other users. For example, users can be assigned to teams, roles, etc., in an organization, and tours can be based on the usage of other users on the same team, in the same role, etc. As an example, tours can be recommended to an analyst based on the features utilized by other analysts within the organization.

In some cases, users may start a tour but not finish it. In some implementations, a system can be configured to track user progress so that a tour can be completed later without necessarily having to repeat all steps in a tour that a user has already completed. In some implementations, a tour can include multiple steps. However, a given user may already be familiar with some of the steps or features highlighted in a tour. In some implementations, steps can be skipped if the user is already familiar with the feature explored in a particular step of a tour. For example, in some implementations, individual steps within a tour can be associated with particular features, and those steps can be skipped if the user has already discovered the associated feature.

These and other approaches as described herein can be used to customize tours such that they are relevant to the user and do not make the user go through steps that they already understand. Personalized tours can help users discover features that are relevant to them, thereby improving user experience, efficiency, and so forth.

In some implementations, the approaches herein can utilize a feature discovery definitions table (or any other data structure that includes the same or similar information). A feature discovery definitions table can be, for example, a tabular data object that can be used to manage and track functionalities of an application, rules for marking features as discovered (discovery conditions), priorities for discovering features, and so forth. For example, in some implementations, a feature may be marked as discovered by a user once the user has interacted with the feature at least a minimum number of times. In some implementations, the feature discovery definitions table can define a baseline priority for a feature, and the baseline priority can be modified based on user-specific usage information and/or the usage of similar users (e.g., users with similar usage patterns and/or users in similar roles).

In some implementations, a recommendation engine can include an algorithm that accepts as input a set of users and information included in the feature discovery definitions table. The recommendation engine can use this information to compute, for each user, a set of features that have been discovered, a set of features that are undiscovered, and a set of features recommended for discovery. In some implementations, the recommended features can be a subset of the undiscovered features. In some implementations, the recommendation engine can rank the recommended features according to a priority. For example, in some implementations, the recommendation engine can use past user behavior as an input and can prioritize features that are similar to features the user has used in the past or can prioritize features used by other users who have similar characteristics as the user. For example, in a work context, features can be recommended based on the features that are used by other employees in the same or a similar job role.

Some implementations described herein relate to feature tours. Feature tours can be personalized and can be based on, for example, a user's past usage of an application. In some implementations, tours are defined using a schema such as a JSON-based schema. For example, a tour can be defined as a JSON object and each element of the object can provide description of the tour. A tour can be, for example, an end-to-end series of steps which can fully explain or explore a particular feature or functionality, although other types of tours are also within the scope of the present disclosure. For example, a tour can range from simply informing a user of the existence of a particular feature to a series of steps that demonstrate multiple features of an application or that walk a user through a particular task or workflow.

In some implementations, the personalized feature tour platform described herein can include functionality that enables application developers to create, modify, or delete tours. This can be significant as the features in an application, the arrangement of an application user interface, and so forth can change overtime, and thus tours may become outdated. In some implementations, tours can be associated with particular application versions. For example, a JSON object can include an element that describes which version or versions of an application the object is applicable to.

In some implementations, a tour can be defined in a JSON object that includes all possible steps in a tour. However, in some cases a user may already be familiar with some steps (e.g., steps associated with particular features, as described herein). In some implementations, the personalized feature tour platform can customize a tour, for example by omitting certain steps, based on the user's past usage of the application (e.g., by considering features that the user is already familiar with). For example, prior to transmitting a tour for consumption by a user, the personalized feature tour platform can remove one or more steps from the tour. Certain steps may be marked as removable or not removable. For example, a step may not be removable if removing it would render the tour non-functional.

In some implementations, the approaches herein can enable tour notifications. Notifications can be provided in a variety of manners. For example, a developer can use an API to implement tour functionality, and the developer can present a notification in an application in response to receiving a response to an API request for one or more recommended tours. In some implementations, a tour notification is provided by displaying a notification within the user interface of an application (e.g., in a notification area of an application), adding a label to a button or other user interface element, etc. A notification area can be advantageous as the user can return to the notification area at a convenient time to access a tour. In some implementations, a developer can choose to begin a tour automatically. For example, rather than providing a notification that a tour is available, an application may simply begin a tour once the application receives a response to the API request for a tour.

### System Overview

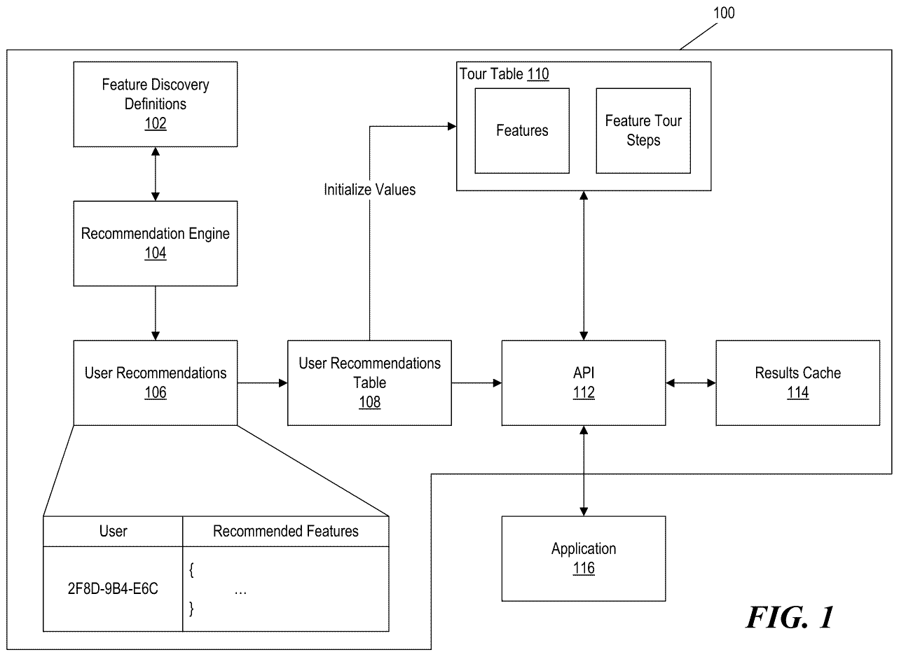

FIG. 1 is a block diagram that illustrates an example personalized feature tour platform 100 according to some implementations. The personalized feature tour platform 100 can include a recommendations engine 104. The recommendations engine 104 can access feature discovery definitions from a feature discovery definitions table 102. The feature discovery definitions table 102 can describe, for example, categories of features, specific events, discovery condition(s), and so forth, as described in more detail herein. The recommendation engine 104 can generate user recommendations 106. For example, the personalized feature tour platform 100 can access user interaction data that indicates which features of an application have been used by a particular user and can generate user recommendations based on the information in the feature discovery definitions table 102 and/or the user interaction data. The personalized feature tour platform 100 can store the user recommendations 106 in a user recommendations table 108. The personalized feature tour platform 100 can update the user recommendations table 108 as users discover features, as features are added or removed from the feature discovery definitions table 102, and/or as values (e.g., minimum uses, weights, etc.) are changed in the feature discovery definitions table 102.

The personalized feature tour platform 100 can include a tour table 110. The tour table 110 can include features and associated feature tour steps. The tour steps can define one or more steps for carrying out a feature tour, as described herein. The personalized feature tour platform 100 can include an API 112 that can be used by an application 116 to access the functionality of the personalized feature tour platform 100. The personalized feature tour platform 100 can include a results cache 114. The results cache 114 can store, for example, information about tours that were provided to the application 116, status of tours provided to the application 116, and so forth. For example, the results cache 114 may store information indicating that a tour has been started, paused, completed, abandoned, etc. The results cache 114 can be used to track a user's progress through a tour so that the user can resume a tour at a later time and/or so that a user is not presented with a tour that they have already completed or permanently dismissed.

In some embodiments, the user recommendations table 108 can be a delta table. A delta table is a type of storage that tracks changes over time, provides reliable updates, and can enable faster retrieval of information from large and complex datasets. In some implementations, a delta table can ensure data consistency using ACID transactions. ACID transactions are transactions that are atomic, consistent, isolated, and durable. That is, a data update either succeeds entirely or fails entirely, follows data integrity rules, is isolated from other operations, and is persisted to storage. In some implementations, a delta table can maintain a transaction log that keeps track of any changes made to the data. This can enable efficient updates, as only changes need to be written when an update is made. In some implementations, a delta table can enable exploration and restoration of previous versions, as a complete log of data and any changes to it can be maintained by the delta table. In some implementations, delta tables can provide improved scalability as compared with some other data storage approaches. In some implementations, the personalized feature tour platform 100 can be configured to support many different applications and many different users, although in some implementations only a single application is supported. Thus, there can be many user recommendations 106. By using a delta table, the personalized feature tour platform 100 can quickly access information in the user recommendations table 108 even as the user recommendations table 108 grows large.

Various aspects of the personalized feature tour platform 100 are described in more detail below.

### Feature Discovery Definitions

One difficulty associated with a personalized feature tour platform or guided tour system (e.g., personalized feature tour platform 100) is the inherent cold start problem with recommending features. For example, new users of an application have no historical usage upon which to base recommendations, which can make it difficult to recommend tours that are relevant to the user. This can be especially true for more complex applications where different users may utilize significantly different functionality. However, for many applications, it is the case that certain features are more likely to be relevant to a wide range of users than certain other features. Further, even without usage data, developers may have a sense, either based on research or the purpose of the application, of which features are more important to expose to the user.

In some implementations, developers, engineering managers, or other stakeholders can manage a table (referred to herein as a feature discovery definition table) that tracks application features and their relative importance. In some implementations, features are added manually. In other implementations, features are added automatically, for example by automatically analyzing a user interface or source code that describes a user interface. For many applications, features can be grouped in a logical manner. For example, in a spreadsheet program, features can be logically divided into data import features, data analysis features, formatting features, charting features, and so forth.

In some implementations, a feature can be defined by a single parameter in a database (or analogous constructs in another type of data store). In some implementations, multiple parameters are used to define a feature. For example, in some implementations, features are defined according to a two-part grouping of categories and events. Categories can group similar features, while events can describe more specific actions that a user can take or more specific features of the application. As an example, a category can be “createChart” and the events can describe specific types of charts that can be created in the application (e.g., scatterplot, bar chart, pie chart, histogram). In some implementations, categories and events can each be assigned priorities. For example all events in the createChart category can have the same category priority, but different chart events can have different event priorities. Such an approach can help developers or others prioritize features in a consistent manner. For example, a developer may conclude that the createChart category should generally be prioritized over data analysis features, which tend to be used by a smaller group of more advanced users, and thus can assign a higher category priority to chart creation than to data analysis. However, within chart creation, common chart types such as bar charts may be given a higher priority than charts that users are less likely to use, such as waterfalls or bubble charts, and thus a developer may assign higher event priorities to bar charts.

In some implementations, events can be assigned discovery condition. The discovery condition can specify a number of times the feature must be used or otherwise exposed to the user before the personalized feature tour platform considers the feature to have been discovered by the user and thus no longer recommends tours to expose the feature to the user. In some implementations, discovery conditions are defined at a feature level (e.g., for specific combinations of categories and events). In some implementations, discovery conditions are defined in two or more parts. For example, discovery conditions can be defined for both categories and events. In some implementations, a user's discovery of events within a particular category is used in determining tours or tour steps to recommend to a user. For example, if a user is already familiar with several charting features, there may be little benefit to presenting a tour to expose more charting features, as the user may organically discover such features. However, it can be the case that presenting a tour can be desirable in such cases, for example when a new charting feature is added or an existing charting feature is significantly modified.

Thus, the feature discovery definition table can provide a source of information for which features are available within an application and the relative importance of exposing such features to users. The feature discovery definition table can be used when making recommendations for new users or for users with limited usage data available, as well as in cases where there is significant usage data available for the user.

### Recommendation Engine

In some implementations, a recommendation engine utilizes a feature discovery definition table (e.g., feature discovery definitions table 102) and log data that indicates how a user has interacted with an application. For example, the recommendation engine can ingest the feature discovery definition table to determine which features can be presented to the user, priorities for showing the features, and criteria for determining when a feature has been discovered.

In some implementations, the recommendation engine determines weights for recommending features without regard to user interactions. That is, weights can be determined independent of log data, and log data can be used to filter the recommended features. For example, the recommendation engine can determine weights for features based on category weights and event weights, as defined in a feature discovery definitions table. As an example, weights can be determined as w=A*category_weight+B*event_weight, where A and B are scaling factors. The scaling factors can be predefined. For example, the scaling factors can be hardcoded or otherwise fixed by the recommendation engine or can be set by application developers who use the recommendation engine to present feature tours to users of their applications. In some implementations, the feature discovery definitions table includes only a single weight (e.g., a baseline weight). Generally, the weights defined in a feature discovery definitions table can be considered baseline weights. These baseline weights can be further modified, as described herein, for example based on usage information.

In some implementations, log data is used to determine which features a user has already been exposed to. For example, for a particular user, the recommendation engine can exclude certain features from being recommended if the user logs show that the user has already used the feature at least a minimum number of times, for example as specified in the feature discovery definition table.

In some implementations, the recommendation engine recommends features to expose to users based on sorting the remaining features (e.g., features that were not filtered out based on analysis of the log data) by weight. For example, the feature with the highest weight can be recommended, or several features having relatively high weights can be recommended.

In some implementations, the recommendation engine determines recommendations based at least in part on the usage patterns of users who share certain similarities. For example, users may have similar job roles or similar usage patterns. In some implementations, the recommendation engine utilizes usage data for a plurality of users. For example, when user roles are used in determining recommendations, a weighting factor can be included based on the features used by other users in the same role. For example, the features that are most used by other users in the same role can be given a higher weight than features that are less frequently used or features that are only used by a small number of users.

In some implementations, the recommendation engine determines relationships between users. For example, the recommendation engine can access job role information for the users. In some implementations, the recommendation engine clusters users based on their usage patterns, job roles, etc. In such an implementation, recommendations are based at least in part on the usage patterns of other users within a cluster. For example, if a user is within a particular cluster and does not use a particular feature (“Feature X”) while other users in the cluster do use Feature X, the recommendation engine gives a higher weight to Feature X. For example, in some implementations, users within a cluster either do (in the case of clustering based on usage) or are expected to (in the case of clustering based on job role) have similar usage patterns. Thus, if there is a feature that other users within the cluster are taking advantage of, it can be assumed that the feature is more likely to be of interest to the user than other features that are not used by other users in the cluster.

In some implementations, recommendations are determined at least in part by graphing relationships between users and features. Bipartite graphs can play a significant role in the recommendation system by modeling the relationships between users and features. In a bipartite graph, a first set of nodes can represent users and a second set of nodes can represent features. Edges can connect users to features. For example, an edge between a user and a feature can indicate that they user has used or discovered the feature. In some implementations, edges are assigned weights based on the usage of the feature (e.g., a weight can be determined based on the number of times a user has used a feature and/or a frequency with which the user uses the feature). In some implementations, weights for making recommendations are based at least in part on the number of edges linking users to particular features and/or the weights of the edges linking users and features.

In some implementations, bipartite graphs are used to identify similar users. For example, after constructing a bipartite graph, similarity measures can be used to determine which users are most like which other users. For example, in some implementations, collaborative filtering is used to determine similarity between users based at least in part on their shared feature usage or discovery. In some implementations, a clustering algorithm such as k-means clustering is used to group users into clusters with similar feature usage patterns.

In some implementations, a bipartite graph can be used to make user-based recommendations, feature-based recommendations, or both. For example, a recommendation system can identify similar users based on their feature usage or discovery, and recommendations can be based at least in part on features that a user has not used or discovered but which other similar users have discovered or used. In a feature-based approach, a recommendation system can identify similar features based at least on part on the shared features used by certain users. In this way, the recommendation system can recommend features that are similar to features already used by the user. For example, the system can determine that scatter plots and histograms are related features, and can give a higher weight to a histogram feature for users who already user the scatter plot feature.

In some implementations, prioritization is based on a combination of the category weight and event weight defined in the feature discovery definitions table 102 along with weights determined by comparing one user's usage to that of other users (e.g., other users with similar usage patterns and/or with the same or similar roles). Thus, for example, a weight w for a feature can be defined in a user-specific manner as w=A*category_weight+B*event_weight+C*relationship_weight, where C is a constant and relationship_weight is determined by analyzing the usage patterns of a user and other users.

Usage data can be collected in various manners. For example, many applications utilize third party analytics technology, although application developers may use their own analytics technology additionally or alternatively. The data collected by analytics technology included in applications can be used to identify features used by a user. Thus, in some implementations, a personalized feature tour platform can utilize data that is already logged for other purposes. In some implementations, a developer may collect data specifically for providing personalized feature tours.

### Feature Tour Schema and API

In some implementations, feature tours are stored in a tour table or other data structure. In some implementations, the tour table is implemented as a delta table. In some implementations, the tour table is a partitioned table. For example, in some implementations, tours for multiple applications are included in the same tour table, and the tour table is partitioned by application. In some implementations, the tour table includes various information used for identifying and storing a particular tour or tours associated with a particular application. For example, the tour table can include keys or fields for parameters such as partition key, application name, feature, and tour. The partition key can identify a specific partition where the tour is stored. Application name can store the name of the application or another application identifier. In some implementations, tours are associated with particular versions of applications. This can be significant as the features that are available in an application can change over time, and thus it can be important to present tours that are relevant to the version of the application that a user is using. A feature parameter can include information about the specific feature associated with a tour. In some implementations, the feature parameter maps the to the category and event parameters in the feature discovery definition table. For example, the feature parameter can be a concatenation of the category and event and in some implementations includes a separator. For example, for a record in the feature discovery definition table with a category of “chart” and an event of “createScatterPlot,” the feature parameter can have a value of “chart_createScatterPlot.” In some implementations, rather than a single feature field, the tour table can include parameters for categories and events, or any other suitable mechanism known to those of skill in the art can be used to map entries in the feature discovery definition table (e.g., features) to tours in the tour table.

The tour parameter can store the tour definition itself (e.g., the contents of the tour). For example, in some implementations, the tour parameter comprises JavaScript Object Notation (JSON) markup that defines various elements of features of the tour, such as anchor IDs for user interface elements and content, titles, and so forth to be displayed during a tour. In some implementations, the tour includes routing information to handle branching conditions within a tour. In some implementations, the JSON is written in a manner that complies with a particular tour framework, such as ngx-ui-tour or React Joyride, although this is not necessary. In some implementations, a translation layer is provided that accesses the tour definition and converts it to syntax for use with a particular tour framework. While specific examples of web-based toolkits are discussed, it will be appreciated that the approaches herein can be readily adapted to other contexts, such as applications written for Android or iOS. For example, in some implementations, the personalized feature tour approaches herein can be configured to work with Apple's TipKit.

In some implementations, an application programming interface (API) is provided. Developers can use the API to implement feature tour functionality into their applications and/or to create or modify tours. The API can include various methods for interacting with tours, for example:
ReadFromTable( )
RecommendedToursForUser(user, appid)
InsertDefaultTour( )
InsertNewStepInTour(feature, index, payload)
UpdateStepInTour(feature, index, payload)
DeleteStepInTour(feature, index)
InsertNewTour(feature, payload)

The RecommendToursForUser( ) method can accept parameters including a user identifier and an application identifier. In some implementations, the application identifier is not included, for example when a recommendation system is configured for a single application. The recommendation system can return a result to an application that includes one or more recommended tours. For example, in some implementations, the API returns an array of tours to the application. The returned tours can be tour identifiers for recommended tours and/or can include the actual tour content (e.g., JSON defining the tour). The returned tour can include all the steps that a developer has defined in the tour table or can include a subset of steps. For example, certain steps can be omitted based on the user's past usage, such that an individual tour is personalized for the user.

Other methods can be useful for developers to manage tours for their applications. For example ReadFromTable( ) can return information from the tour table, such as what tours are currently defined, the contents of tours, and so forth. InsertDefaultTour( ) can create a default tour for an application. InsertNewStepInTour( ) can be used by developers to add a step to a tour when there are changes to an application (e.g., when additional UI features are added). The developer can specify the relevant feature, the index (e.g., where in an existing tour the new step should be added), and the payload (e.g., the JSON content to be added). In some implementations, the recommendation system includes functionality for parsing tours so that an indexed set of steps can be presented to the developer, thereby making it easier for the developer to update individual steps, add steps at particular locations with a tour, and so forth. The UpdateStepInTour( ) method can be used to update an existing step in a tour. The developer can specify the relevant feature, the index of the step to be updated, and the payload. The payload can be, for example, new JSON that replaces the existing step in the tour. DeleteStepInTour( ) can be used by developers to remove a step from a tour. This can be useful when, for example, a developer wants to simplify a tour, either to make the tour shorter or because the application has been changed and certain steps in the tour are no longer relevant. InsertNewTour( ) can be used to create a new tour for a particular feature with a specified payload that defines the steps of the tour.

In some implementations, tours can be stored in a tour table or other data store. In some embodiments, the tour table can be a delta table. In some implementations, the tour table can be a partitioned table. For example, in some implementations, the tour table can include tours for multiple applications, and the tour table can be partitioned by application. In some implementations, the tour table can include various information used for identifying and storing a particular tour associated with a particular application. For example, in some implementations, the tour table can include keys or fields for parameters such as partition key, application name, feature, and tour. The partition key can identify a specific partition where the tour is stored. Application name can store the name of the app or another application identifier. Feature can include information about the specific feature associated with a tour (e.g., can identify the feature associated with the tour). The tour itself can comprise a description of various tour components. In some implementations, the tour can be written in JavaScript Object Notation (JSON) or in another format such as YAML. In general, a tour can be written in structured format. The JSON can define various elements or features of the tour, such as anchor IDs, content, titles, etc., to be displayed during a tour. In some implementations, the tour can comply with a schema for a particular tour framework, such as ngx-ui-tour, although as described herein, this is not necessary, and the tour may not be written to specifically target any particular framework.

### In-App Notifications and Tour Presentation

The guided tour system described herein provides mechanisms for creating feature tours, identifying which tours are most relevant to particular users, and delivering these tours to users. Developers can identify and retrieve a relevant feature tour by providing a user identifier and an application identifier to the guided tour system via an Application Programming Interface (API) (or depending on the implementation, using only a user identifier and/or using other information such as application version data). The guided tour system then returns a relevant tour to the application.

In some implementations, the specific implementation of guided tours within an application is left to the discretion of the developer. For instance, a developer may utilize various libraries, such as ngx-ui-tour for Angular-based applications, to present the guided tour to the user. The objective of the present guided tour system is not to enforce a particular method of displaying a tour but rather to provide a mechanism for identifying and delivering relevant tours.

In certain implementations, guided tours can be stored and provided in a JavaScript Object Notation (JSON) format or other format, which may or may not be compatible with a specific tour framework. The guided tour system may include a translation layer capable of converting a guided tour from the format used in the tour table to a format suitable for the particular tour framework employed by an application. In some implementations, this translation or conversion task may be delegated to the application developer.

Developers have the flexibility to choose various methods for presenting guided tours to users within their applications. Many applications feature a notification center or similar functionality that allows developers or other stakeholders to provide information to users. For example, the notification center may include a badge or similar indicator signifying the availability of new information or a new tour.

In some implementations, a developer may request a single tour using the guided tour system, and an indication that the tour is available can be added to an application's notification center. In some implementations, the guided tour system is configured to provide multiple guided tours in response to a request from an application. For instance, a developer may specify a number of tours to be provided to a user of the application. Consequently, the guided tour system can deliver multiple tours, each of which can be added to the notification center.

Some applications include a notification center to communicate updates from developers to users or to facilitate user-to-user communication. A badge number displayed in the notification center or in an icon for a notification center can indicate the number of tours recommended to the user (though this number can also include other notifications that are not related to recommended tours). In the notification center, guided tours recommended to the user can be exposed. In some implementations, users have the option to either ‘dismiss’ the tour notification, causing the notification to permanently disappear, or ‘start’ the tour. If a tour is prematurely terminated before completion, the banner can remain in the notification center, as the system will infer that the abandonment occurred accidentally or that the user would like to return to the tour at a later time. In some implementations, dismissed tours are resurfaced to the user at a later time. For example, a user may accidentally dismiss a tour or may dismiss a tour because they are busy or want to clear out their notifications, but in reality, may actually be interested in the tour.

### Example Implementations

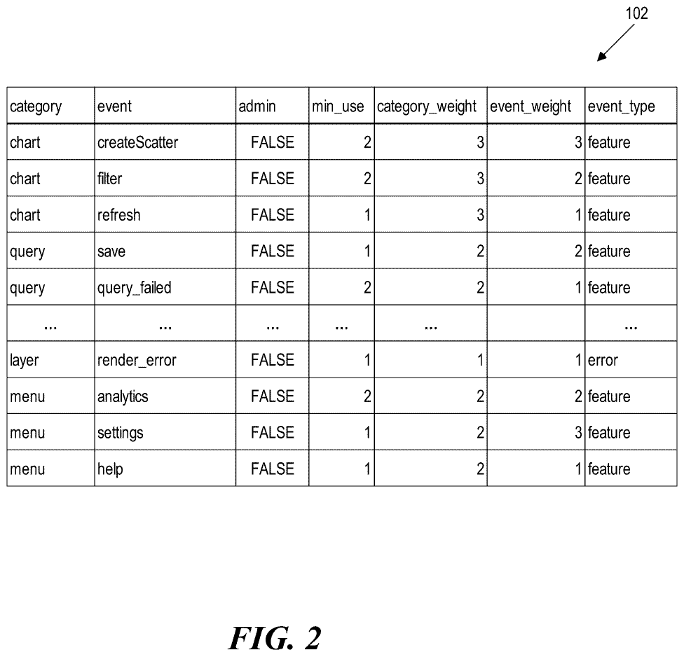

FIG. 2 shows an example feature discovery definitions table 102 according to some implementations. As shown in FIG. 2, the feature discovery definitions table 102 can include various fields that can define features, discovery criteria, and so forth. For example, in FIG. 2, the feature discovery definitions table 102 includes an event field that describes specific events that can occur in an application. The events are grouped into categories, as indicated by the category field. As described herein, a feature can be defined as a combination of a category and an event (e.g., an underscore-separated concatenation of the category and the event), although this is not necessary and in some cases a feature can be defined in a single field. The feature discovery definitions table 102 can include a minimum usage (min_use) field (e.g., a discovery condition) that defines how many times a user should interact with a particular feature before it is considered that the user is familiar with the feature. The minimum usage field can be, for example, designated by a developer. For example, a developer may want to expose certain features multiple times if they are more complex or may only consider a feature to have been discovered if a user has had multiple interactions with the features, while simpler features such as refresh and save can have fewer minimum uses as users are likely to grasp these concepts quickly. In some implementations, the feature discovery definitions table 102 includes a field that indicates a required privilege level or other categorization for features or events. For example, in the feature discovery definitions table 102, an “admin” column indicates if the feature is only exposed to administrators, in which case the corresponding tour may not be presented to users without administrator privileges

As described herein, the feature discovery definitions table 102 can include a large number of features, and different features can have different relative importance for being presented to users. In some implementations, the feature discovery definitions table 102 includes a category_weight field and an event_weight field, where category_weight indicates a relative importance of a category as compared with other categories, and event_weight indicates relative importance of an event as compared with other events within a category. As described herein, the category_weight values and event_weight values can be multiplied by constants. Thus, depending on the constants, greater importance can be assigned to categories or to events. In general, the feature discovery definitions table 102 can include a baseline weight, which can be made up of one field or multiple fields (e.g., category_weight and event_weight as shown in FIG. 2).

In some implementations, the feature discovery definitions table 102 includes an event_type field that indicates a type of event. For example, an event can be categorized as a feature (e.g., something a user might choose to interact with or use to accomplish a task) or an error (which may only be presented to a user when an error condition occurs within the application). While presenting feature tours can be a goal of the current disclosure, it can also be valuable to present tours in response to errors occurring. For example, if a layer render_error occurs, it can be beneficial to present a tour that explains the error, steps for resolving the error, etc.

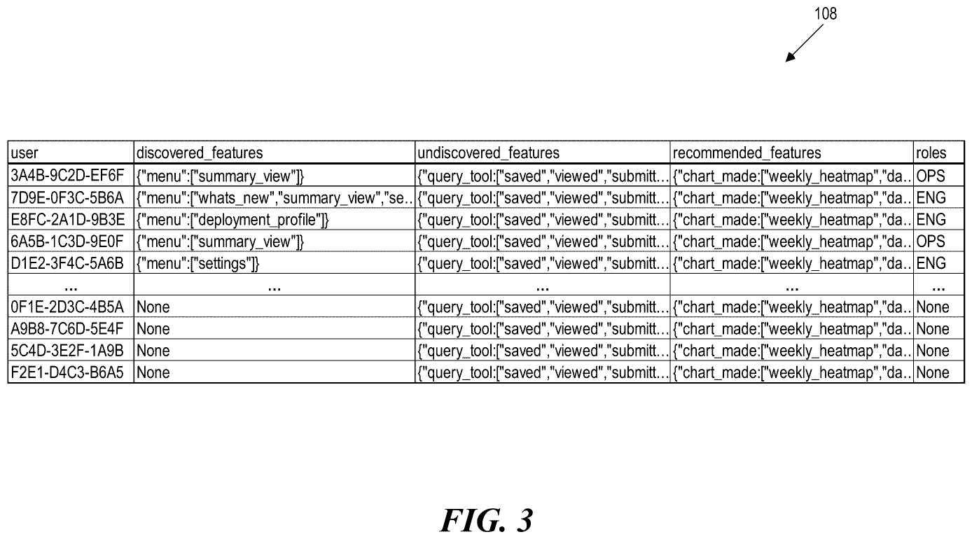

FIG. 3 shows an example of a user recommendation table 108 according to some implementations. The user recommendation table 108 can include fields for users, discovered features, undiscovered features, recommended features, user roles, and so forth. In an initial state (e.g., a new user state), the discovered_features value can be empty and all features included in the feature discovery definitions table 102 can be included in the undiscovered_features field, as the user has not yet discovered any features. The recommended_features field can include one or more features for which tours are recommended, for example based on calculating weights using the weighting values (e.g., category_weight and event_weight) specified in the feature discovery definitions table 102. The roles field can indicate one or more roles (e.g., job roles) associated with a user. As described herein, in some implementations, recommended features are based at least in part on user role, for example by analyzing the usage of other users with the same or a similar role. In some implementations, the role field is populated by querying another database (e.g., a human resources database). In some implementations, for example once a user has started using the application, the recommended_features can be determined at least in part based on the user's usage of the application.

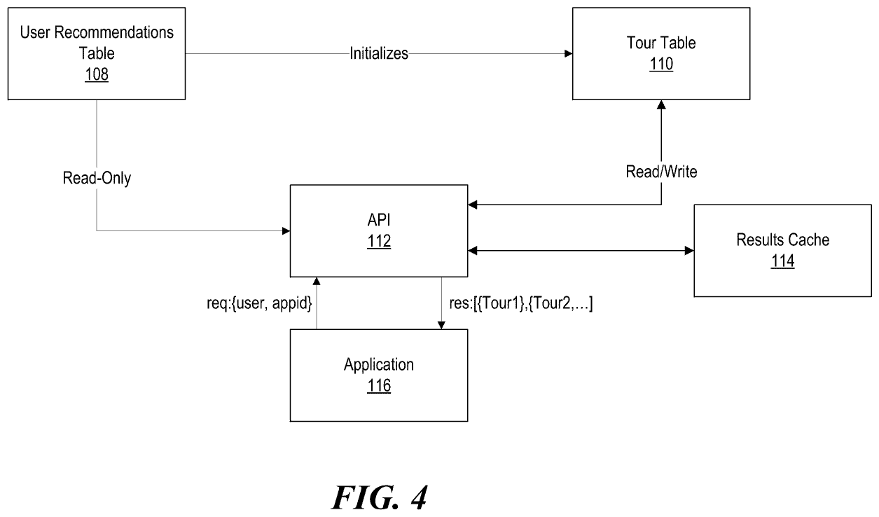

FIG. 4 is a block diagram that illustrates certain features of a personalized tour recommendation system and an application that interacts with the personalized tour recommendation system according to some implementations. An application 116 can send a request to a system using an API 112. The request can include, for example, a user identifier and an application identifier. In some implementations, only a user identifier is sent, for example when a recommendation system is configured for only a single application. The recommendation system can query the user recommendations table 108 to determine one or more recommended features for the user, and can query the tour table 110 to identify particular tours based on the recommended features. The system can return a result to the application 116 that includes one or more recommended tours. The results can be cached in a results cache, such as the results cache 114 shown in FIG. 1. The results cache 114 can include indications of a user's progress through a tour (e.g., which steps of a tour a user has completed, whether or not a user has dismissed a tour, etc.), and tours can be marked as completed once a user has gone through all the steps of a tour.

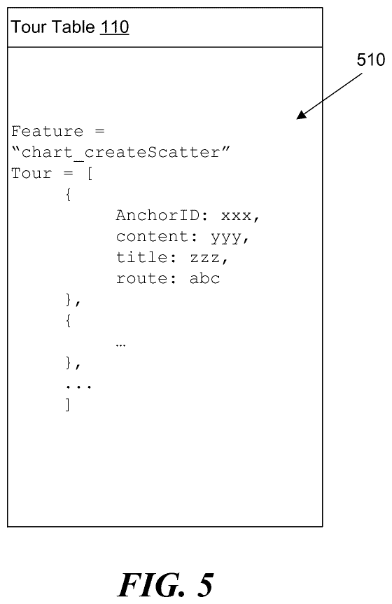

FIG. 5 illustrates an example entry 510 in a tour table 110 according to some implementations. The entry 510 can include a “Feature” parameter that identifies the particular feature that the entry 510 relates to. For example, in FIG. 5, the entry 510 is for the “chart_createScatter” feature. As described herein, the Feature parameter value can be a combination (e.g., an underscore-separated concatenation) of a category parameter and an event parameter as defined in a feature discovery definition table. The Tour parameter can contain an array that identifies particular steps in a feature tour. Each step can include one or more parameters, such as an AnchorID, content, title, and/or route. The AnchorID parameter can define a particular UI element that the feature step is bound to. For example, the AnchorID can specify a particular UI element that indicates where information should be displayed (e.g., so that overlaid text appears near the UI element) and/or can define a UI element to highlight or otherwise draw the user's attention to, such as drawing a box around or pointing at arrow at the UI element. The content parameter can specify what content (e.g., text, images, etc.) should be displayed to the user. The title parameter can specify a title for a popup or overlay. The route parameter can specify a particular place to navigate to within an application before the step is displayed. For example, in an Angular application, a router is used to move between different views in an application. Other frameworks can implement similar functionality, which can be reflected in the entry 510, or the personalized feature tour platform can include a translation layer to convert the entry 510 to a format that is compatible with another framework.

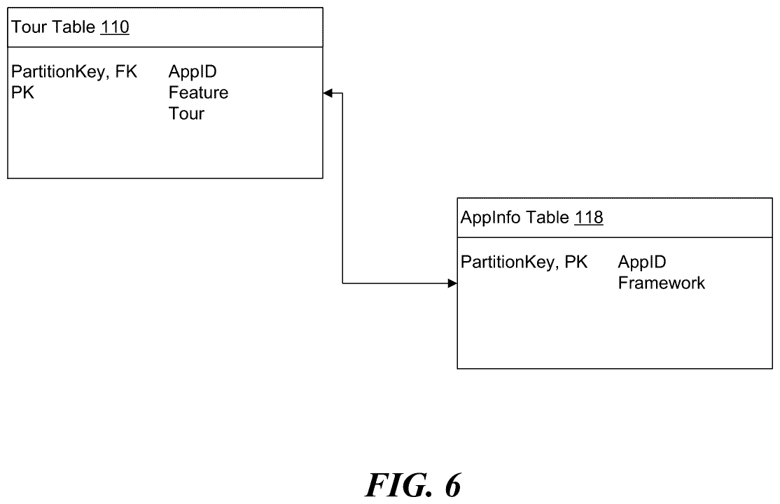

FIG. 6 is a diagram that shows an example of linkage between a tour table 110 can an application information table 118. As described herein, the tour table 110 can include a partition key, foreign key, primary key, application id (AppID), feature, and tour. The application information table 118 can contain information about applications. For example, the application information table 118 can include application IDs (AppIDs) and an indication of which framework is used by the application for providing feature tours. This information can be used in determining the appropriate format for providing tours to an application. For example, as described herein, in some implementations, a translation layer is used to convert tours in the tour table 110 to a particular format, such as to a format appropriate for ngx-ui-tour or React Joyride. In some implementations, the framework can indicate a specific tour framework that a developer wishes to use for providing feature tours. For example, a developer of a React application may choose to use Joyride, Shepherd, Intro.js, walktour, Reactour, etc., for providing feature tours.

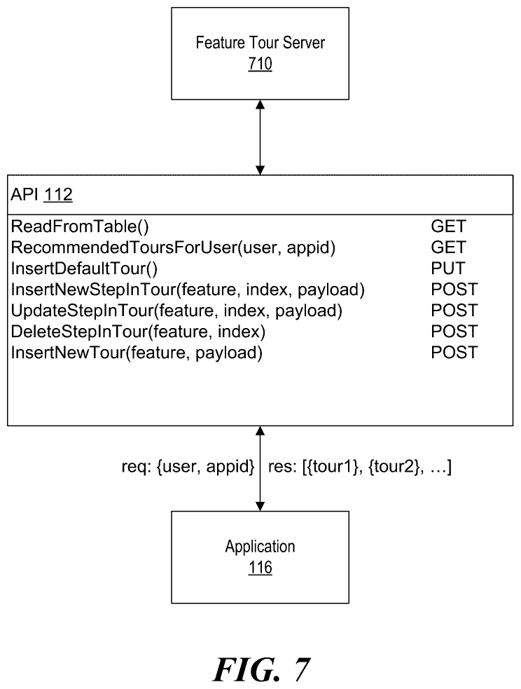

FIG. 7 is a drawing that illustrates an example API request according to some implementations. An application 116 can utilize an API 112 to send a request to a feature tour server 710. As shown in FIG. 7, the API 112 can support various methods. In FIG. 7, the application 116 utilizes the RecommendedToursForUser( ) method to get a list of tours for a particular user, and the feature tour server 710 issues a response (utilizing the API 112) including one or more tours to the application 116. The feature tour server 710 can implement, for example, the personalized feature tour platform 100 described herein.

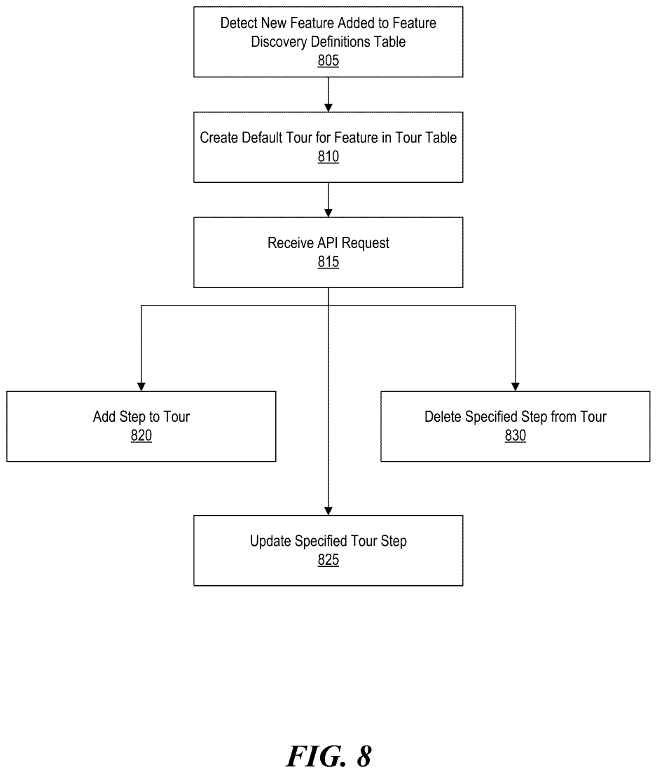

FIG. 8 is a flowchart that illustrates an example process for creating and managing feature tours according to some implementations. At operation 805, a personalized feature tour platform 100 can detect that a new feature has been added to a feature discovery definitions table (e.g., feature discovery definitions table 102 of FIG. 1). The personalized feature tour platform can, at operation 810, create a default tour for the added feature in a tour table (e.g., tour table 110). At operation 815, the personalized feature tour platform can receive an API request. As described herein, various types of API requests are possible for managing a tour. For example, if a developer or other user submits an API request to add a new step to the tour, the system can add the new step at operation 820. If the user submits an API request to update an existing step in the tour, the system can update the specified step at operation 825. If the user submits an API request to delete a step, the system can delete the specified step from the tour at operation 830.

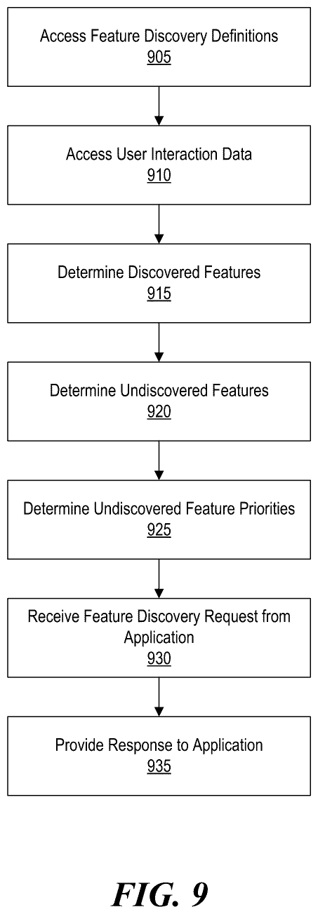

FIG. 9 is a flowchart that illustrates an example tour deployment process according to some implementations. At operation 905, a system can access feature discovery definitions, for example as defined in a feature discovery definitions table 102. At operation 910, the system can access logged user interaction data. At operation 915, the system can analyze the logged user interaction data to determine which features a user has interacted with (e.g., how many times a user has interacted with particular features of an application). At operation 915, the system can determine discovered features, which can be features that the user has interacted with at least the minimum number of times specified in the feature discovery definitions table 102. At operation 920, the system can determine undiscovered features, which can be features in the feature discovery definitions table 102 that a user has not yet interacted with at least the minimum number of times specified in the feature discovery definitions table 102. The discovered features and undiscovered features can be stored in a user recommendations table 108. At operation 925, the system can determine priorities for the undiscovered features, for example based on the category priorities and event priorities specified in the feature discovery definitions table 102. In some implementations, the system computes priorities for all features. In some implementations, the system computes priorities as features are added to the feature discovery definitions table 102. This can be advantageous in cases where the priorities are not dependent on particular users, particular usage histories, etc.

At operation 930, the system can receive a feature discovery request from an application. The request can be submitted using an API, such as API 112. The API request can include an application identifier and a user identifier. The system can determine, for example based on the priorities of undiscovered features, one or more recommended tours for the user. The system can, at operation 935, provide a response to the application. The response can include one or more tours. In some implementations, the API request specifies a number of tours or a maximum number of tours. For example, a developer may only want to present one tour at a time, or may want to place multiple notifications in an application indicating multiple tours that are relevant to the user.

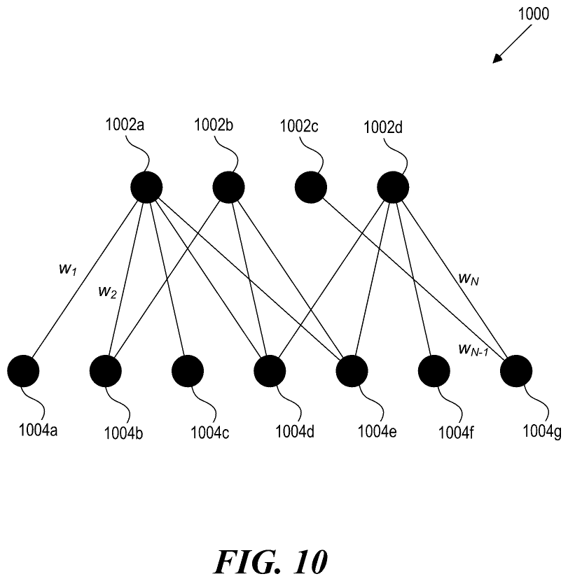

FIG. 10 is a flowchart that illustrates an example process for creating and modifying a feature tour according to some implementations. At operation 1005, a recommendation system can detect that a new feature has been added to a feature discovery definitions table. As described herein, the feature can be added to the feature discovery definitions table manually or automatically. At operation 1010, the recommendation system can create a default tour for the new feature in a tour table. The default tour can be, for example, an empty tour with no steps specified. At operation 1015, the system can receive an API request. For example, a developer can submit an API request to modify the tour for the new feature. in some implementations, a tool is provided that provides a user interface for managing and modifying tours. The recommendation can add a step to the tour at operation 1020 if the API request is to add a step. The API request can specify a location (e.g., index) where the step is to be added. The API request can include a payload that defines the step in the tour. If the request to update a tour step, the system can update the specified tour step at operation 1025. If the request is to delete a step from the tour, the system can delete the specified step at operation 1030.

FIG. 10 is a diagram that schematically illustrates a bipartite graph according to some implementations. The bipartite graph 1000 shows relationships between users 1002a-1002d (collectively users 1002 or user nodes 1002) and features 1004a-1004g (collectively features 1004 or feature nodes 1004). The user nodes 1002 are connected to feature nodes 1004 by edges. The edges can have weights w₁-w_{N}, and the weights can indicate the engagement of a particular user with a particular feature. For example, a weight can be based on the number of times a user has accessed a feature, the frequency with which a user accesses a feature, and so forth. In some implementations, a weight can be based at least in part on relative priorities (e.g., weights) assigned in the feature discovery definitions table.

As described herein, a bipartite graph can be used in determining which features to prioritize for presentation to a user via a feature tour. For example, features that are used by a large number of users, features that are frequently used, etc., may be prioritized for presentation to a user via a feature tour than other features that are less frequently used (e.g., features with fewer connecting edges and/or smaller weights).

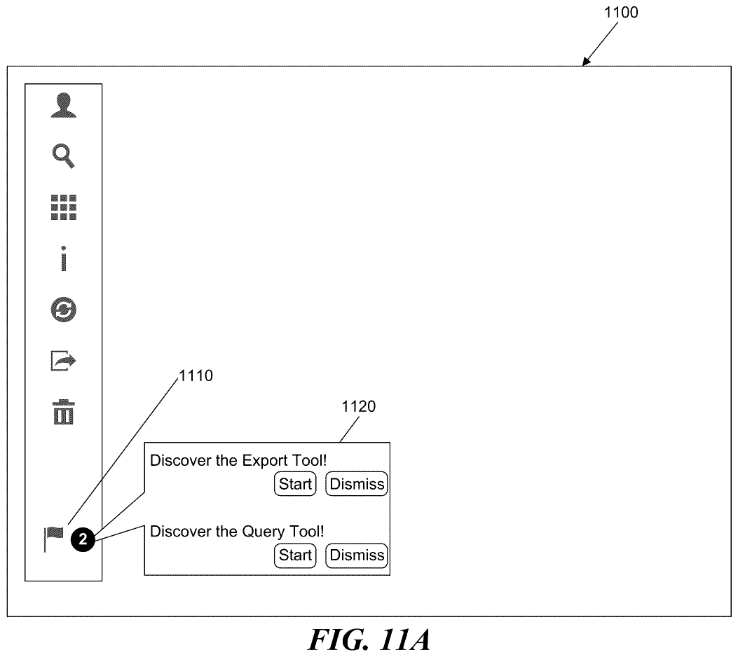

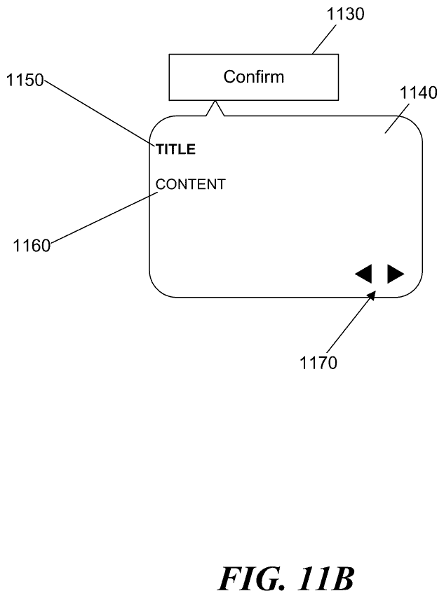

FIG. 11A is a drawing that illustrates an example user interface according to some implementations. The user interface 1100 includes a notification indicator 1110. The notification indicator 1110 can include a badge or other indication that there are pending notifications and can, in some cases, include a count of the number of new notifications. When a user clicks on the user interface 1100 or otherwise activates the notification indicator 1110, the user interface can display a notification pane 1120. The notification pane 1120 can indicate which tours have been selected for presentation to the user. The notification pane 1120 can include buttons so that a user can interact with the tours, for example by dismissing a tour or starting a tour.

FIG. 11B is a drawing that illustrates a user interface for a tour step according to some implementations. The user interface can include a button 1130. The button 1130 can be associated with an identifier (e.g., an anchor ID). Step information (e.g., title 1150 and content 1160) can be displayed in a popup or other user interface element 1140. The other user interface element 1140 can include navigation buttons 1170 so that a user can navigate through steps of a tour. In some cases, a tour can progress automatically in response to user actions within a user interface. For example, the next step in a tour can be displayed with a user clicks a button or otherwise performs an action within an application's user interface. The location where the other user interface element 1140 is displayed can be defined in a tour (e.g., using the ‘anchor’ key) and the content can be defined in the tour using the ‘title’ and ‘content’ keys. If there is a need to display a particular UI element or screen for a tour step, this can be specified using the ‘route’ key.

### Computer System

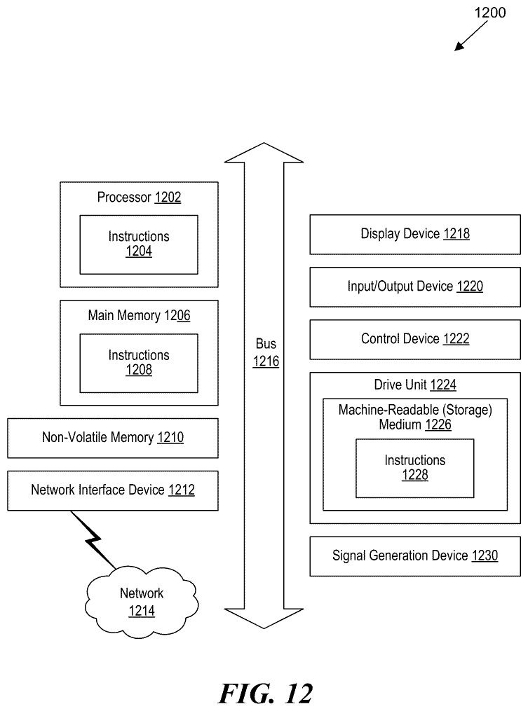

FIG. 12 is a block diagram that illustrates an example of a computer system 1200 in which at least some operations described herein can be implemented. As shown, the computer system 1200 can include: one or more processors 1202, main memory 1206, non-volatile memory 1210, a network interface device 1212, a video display device 1218, an input/output device 1220, a control device 1222 (e.g., keyboard and pointing device), a drive unit 1224 that includes a machine-readable (storage) medium 1226, and a signal generation device 1230 that are communicatively connected to a bus 1216. The bus 1216 represents one or more physical buses and/or point-to-point connections that are connected by appropriate bridges, adapters, or controllers. Various common components (e.g., cache memory) are omitted from FIG. 12 for brevity. Instead, the computer system 1200 is intended to illustrate a hardware device on which components illustrated or described relative to the examples of the figures and any other components described in this specification can be implemented.

The computer system 1200 can take any suitable physical form. For example, the computing system 1200 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1200. In some implementations, the computer system 1200 can be an embedded computer system, a system-on-chip (SOC), a single-board computer system (SBC), or a distributed system such as a mesh of computer systems, or it can include one or more cloud components in one or more networks. Where appropriate, one or more computer systems 1200 can perform operations in real time, in near real time, or in batch mode.

The network interface device 1212 enables the computing system 1200 to mediate data in a network 1214 with an entity that is external to the computing system 1200 through any communication protocol supported by the computing system 1200 and the external entity. Examples of the network interface device 1212 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1206, non-volatile memory 1210, machine-readable medium 1226) can be local, remote, or distributed. Although shown as a single medium, the machine-readable medium 1226 can include multiple media (e.g., a centralized/distributed database and/or associated caches and servers) that store one or more sets of instructions 1228. The machine-readable medium 1226 can include any medium that is capable of storing, encoding, or carrying a set of instructions for execution by the computing system 1200. The machine-readable medium 1226 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1210, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1204, 1208, 1228) set at various times in various memory and storage devices in computing device(s). When read and executed by the processor 1202, the instruction(s) cause the computing system 1200 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A method for providing a personalized feature tour of software applications to a user, the method comprising:
accessing feature discovery definitions in a feature discovery definitions table,
wherein the feature discovery definitions are associated with at least one software application,
wherein each feature discovery definition of the feature discovery definitions corresponds to a feature of a plurality of features,
wherein each feature discovery definition of the feature discovery definitions comprises at least one of: a category, an event, a category priority, an event priority, or a discovery condition, and
wherein the category and event together identify the corresponding feature;
accessing user interaction data associated with a user,
wherein the user interaction data is indicative of usage of each feature of the plurality of features by the user;
determining, based on the user interaction data and the feature discovery definitions table, a set of discovered features,
wherein the set of discovered features comprises features that satisfy the corresponding discovery condition of the corresponding feature discovery definition;
determining a set of undiscovered features comprising features that are included in the feature discovery definitions table and not included in the set of discovered features;
determining, for each undiscovered feature of the set of undiscovered features, a priority of the undiscovered feature,
wherein the priority is calculated as a weighted sum of the category priority and the event priority;
receiving, from a software application of the at least one software application via an application programming interface (API), a request for a feature tour for the user;
identifying, based on the priority of each undiscovered feature, a recommended feature tour in a tour table; and
transmitting a content of the recommended feature tour to the application.

2. The method of claim 1, wherein the feature tour comprises a plurality of steps, wherein the method further comprises:
identifying a step in the recommended feature tour that is associated with a discovered feature; and
removing the identified step from the recommended feature tour prior to transmitting the recommended feature tour to the application.

3. A method for providing a personalized feature tour of software applications to a user, the method comprising:
accessing feature discovery definitions in a feature discovery definitions table,
wherein the feature discovery definitions are associated with at least one software application,
wherein each feature discovery definition of the feature discovery definitions corresponds to a feature of a plurality of features,
wherein each feature discovery definition of the feature discovery definitions comprises at least one of: a feature identifier, a baseline priority, or a discovery condition;
accessing user interaction data associated with a user,
wherein the user interaction data is indicative of usage of each feature of the plurality of features by the user;
determining, based on the user interaction data and the feature discovery definitions table, a set of discovered features,
wherein the set of discovered features comprises features that satisfy the corresponding discovery condition of the corresponding feature discovery definition;
determining a set of undiscovered features comprising features that are included in the feature discovery definitions table and not included in the set of discovered features;
determining, for each undiscovered feature of the set of undiscovered features, a priority of the undiscovered feature,
wherein the priority is based at least in part on the baseline priority;
receiving, from a software application of the at least one software application via an application programming interface (API), a request for a feature tour for the user;
identifying, based on the priority of each undiscovered feature, a recommended feature tour in a tour table; and
transmitting an indication of the recommended feature tour to the application.

4. The method of claim 3, further comprising:
transmitting a content of the recommended feature tour to the application;
receiving interaction data indicative of user progress through the recommended feature tour;
recording at least a portion of the interaction data in a results cache;
determining that all steps of the recommended feature tour are complete; and
updating the results cache to indicate that the user has completed the recommended feature tour.

5. The method of claim 3, wherein the priority for each undiscovered feature is further based on a feature usage history of the user, wherein the priority is increased when the feature is in a same category as other features used by the user.

6. The method of claim 3, wherein the priority for each undiscovered feature is determined by:
accessing feature usage information for other users in a same job role;
constructing a bipartite graph that connects a plurality of features to a plurality of users;
determining a relative weighting of each undiscovered feature as compared with other features included in the bipartite graph, wherein the relative weighting is proportional to a number of users who have used each feature of the plurality of features; and
adjusting the baseline priority of each undiscovered feature based on the relative weighting.

7. The method of claim 3, wherein the feature tour comprises a plurality of steps, wherein the method further comprises:
identifying a step in the recommended feature tour that is associated with a discovered feature; and
removing the identified step from the recommended feature tour prior to transmitting the recommended feature tour to the application.

8. The method of claim 3, wherein the discovery condition indicates a minimum number usage count required for the feature to be treated as discovered.

9. The method of claim 3, wherein the tour table comprises tours for a plurality of applications, and
wherein the tour table is partitioned by application of the plurality of applications.

10. The method of claim 3, wherein the feature identifier comprises a category and an event,
wherein the category is associated with a category priority, and
wherein the event is associated with an event priority.

11. The method of claim 10, wherein the baseline priority is determined via a weighted sum of the category priority and the event priority.

12. The method of claim 3, further comprising:
detecting an addition of an added feature to the feature discovery definitions table; and
generating a new tour for the added feature; and
storing the new tour in the tour table.

13. The method of claim 3, further comprising:
receiving an API request to insert a new step in an existing feature tour,
wherein the API request comprises a specified feature, a specified index, and a specified payload,
wherein the specified index indicates location in the existing feature tour to insert the new step, and
wherein the specified payload indicates a content of the new step in the existing feature tour; and
inserting the new step into the feature tour.

14. The method of claim 3, further comprising:
receiving an API request to modify an existing step in an existing feature tour,
wherein the API request comprises a specified feature, a specified index, and a specified payload,
wherein the specified index indicates the existing step in the existing feature tour, and
wherein the specified payload indicates a new content of the existing step in the existing feature tour; and
updating the existing step with the specified payload.

15. The method of claim 3, further comprising:
receiving an API request to delete an existing step in an existing feature tour,
wherein the API request comprises a specified feature and a specified index, and
wherein the specified index indicates the existing step in the existing feature tour, and
deleting the existing step from the existing feature tour.

16. A system comprising:
at least one hardware processor; and
at least one non-transitory memory storing instructions which, when executed by the at least one hardware processor, cause the system to:
access feature discovery definitions in a feature discovery definitions table,
wherein the feature discovery definitions are associated with an application,
wherein each feature discovery definition of the feature discovery definitions corresponds to a feature of a plurality of features,
wherein each feature discovery definition of the feature discovery definitions comprises at least one of: a feature identifier, a baseline priority, or a discovery condition;
access user interaction data associated with a user,
wherein the user interaction data is indicative of usage of each feature of the plurality of features by the user;
determine, based on the user interaction data and the feature discovery definitions table, a set of discovered features comprising features that satisfy the corresponding discovery condition of the corresponding feature discovery definition;
determine a set of undiscovered features,
wherein the set of undiscovered features comprises features that are included in the feature discovery definitions table and not included in the set of discovered features;
determine, for each undiscovered feature of the set of undiscovered features, a priority of the undiscovered feature,
wherein the priority is based at least in part on the baseline priority;
receive, from an application via an application programming interface (API), a request for a feature tour for the user;
identify, based on the priority of each undiscovered feature, a recommended feature tour in a tour table; and
transmit an indication of the recommended feature tour to the application.

17. The system of claim 16, wherein the instructions are further configured to cause the system to:
transmit a content of the recommended feature tour to the application;
receive interaction data indicative of user progress through the recommended feature tour;
store at least a portion of the interaction data in a results cache;
determine that all steps of the recommended feature tour are complete; and
update the results cache to indicate that the user has completed the recommended feature tour.

18. The system of claim 16, wherein the priority for each undiscovered feature is further based on a feature usage history of the user, wherein the priority is increased when the feature is in a same category as other features used by the user.

19. The system of claim 16, wherein the priority for each undiscovered feature is determined by:
accessing feature usage information for other users in a same job role;
constructing a bipartite graph that connects a plurality of features to a plurality of users;
determining a relative weighting of each undiscovered feature as compared with other features included in the bipartite graph, wherein the relative weighting is proportional to a number of users who have used each feature of the plurality of features; and
adjusting the baseline priority of each undiscovered feature based on the relative weighting.

20. The system of claim 16, wherein the feature tour comprises a plurality of steps, wherein the instructions are further configured to cause the system to:
identify a step in the recommended feature tour that is associated with a discovered feature; and
remove the identified step from the recommended feature tour prior to transmitting the recommended feature tour to the application.
